(19) United States
(12) Patent Application Publication
(10) Pub. No.: US 2023/0067108 A1
(43) Pub. Date: Mar. 2, 2023

(54) COMPUTER ANALYSIS OF ROUTING DATA ENABLED FOR AUTONOMOUS OPERATION AND CONTROL

(71) Applicant: KYNDRYL, INC., New York, NY (US)

(72) Inventors: Prasanna Kumar Dixit J, Bangalore (IN); Sharat K. Tripathy, Bangalore (IN); Mohammed Amjed Ali, Hyberabad (IN)

(21) Appl. No.: 17/445,852

(22) Filed: Aug. 25, 2021

(51) Int. Cl. H04L 12/707; H04L 12/733; H04L 12/717; H04L 12/751; H04L 12/725

(52) U.S. Cl. CPC H04L 45/24; H04L 45/126; H04L 45/42; H04L 45/02; H04L 45/302

(57) ABSTRACT

A system, method, and computer program product for implementing autonomous operation optimization and control is provided. The method includes defining nodes associated with facilities at differing geographical locations. A first node is assigned as a location of an entity and a second node is assigned as a location of a warehouse comprising products for delivery. A value for the first node and second node is determined based on a modification of a node route and clusters associated with geographical locations of the nodes are defined. Likewise, a network comprising routes extending between the nodes and facilities is defined. The nodes, results of assigning, the value, the clusters, and the network are analyzed. In response to the analysis, a recommendation for a facility and specified route is generated and operational functionality of an apparatus with respect to facility and the specified route is enabled in accordance with the recommendations.

### BACKGROUND

The present invention relates generally to automating operation optimization and control of facility and route selection and in particular to improving autonomous software technology associated with enabling operational functionality of an apparatus with respect to a facility and an associated route. Typical route selection assignments includes an inaccurate process with little flexibility. Optimizing automated operations may include a complicated process that may be time consuming and require a large amount of resources. Accordingly, there exists a need in the art to overcome at least some of the deficiencies and limitations described herein above.

### SUMMARY

A first aspect of the invention provides a hardware device comprising a processor coupled to a computer-readable memory unit, the memory unit comprising instructions that when executed by the processor implements an autonomous operation optimization and control method comprising: defining, by a processor of a hardware device, a plurality of nodes associated with facilities at differing geographical locations; first assigning, by the processor, a first node, of the plurality of nodes, as a location of an entity; second assigning, by the processor, a second node, of the plurality of nodes, as a location of a warehouse comprising products for delivery; determining, by the processor, a value for the first node and the second node based on a modification of a route extending between the first node and the second node; defining, by the processor, clusters associated with a group of geographical locations of the plurality of nodes; defining, by the processor, a network comprising a plurality of routes extending between the plurality of nodes and the facilities; analyzing, by the processor, the plurality of nodes, results of the first assigning and the second assigning, the value, the clusters, and the network; generating, by the processor based on results of the analyzing, a recommendation for a facility of the facilities and a specified route of the plurality of routes; and enabling, by the processor, operational functionality of an apparatus with respect to the facility and the specified route in accordance with the recommendations.

A second aspect of the invention provides an autonomous operation optimization and control method comprising: defining, by a processor of a hardware device, a plurality of nodes associated with facilities at differing geographical locations; first assigning, by the processor, a first node, of the plurality of nodes, as a location of an entity; second assigning, by the processor, a second node, of the plurality of nodes, as a location of a warehouse comprising products for delivery; determining, by the processor, a value for the first node and the second node based on a modification of a route extending between the first node and the second node; defining, by the processor, clusters associated with a group of geographical locations of the plurality of nodes; defining, by the processor, a network comprising a plurality of routes extending between the plurality of nodes and the facilities; analyzing, by the processor, the plurality of nodes, results of the first assigning and the second assigning, the value, the clusters, and the network; generating, by the processor based on results of the analyzing, a recommendation for a facility of the facilities and a specified route of the plurality of routes; and enabling, by the processor, operational functionality of an apparatus with respect to the facility and the specified route in accordance with the recommendations.

A third aspect of the invention provides a computer program product, comprising a computer readable hardware storage device storing a computer readable program code, the computer readable program code comprising an algorithm that when executed by a processor of a hardware device implements an autonomous operation optimization and control, the method comprising: defining, by the processor, a plurality of nodes associated with facilities at differing geographical locations; first assigning, by the processor, a first node, of the plurality of nodes, as a location of an entity; second assigning, by the processor, a second node, of the plurality of nodes, as a location of a warehouse comprising products for delivery; determining, by the processor, a value for the first node and the second node based on a modification of a route extending between the first node and the second node; defining, by the processor, clusters associated with a group of geographical locations of the plurality of nodes; defining, by the processor, a network comprising a plurality of routes extending between the plurality of nodes and the facilities; analyzing, by the processor, the plurality of nodes, results of the first assigning and the second assigning, the value, the clusters, and the network; generating, by the processor based on results of the analyzing, a recommendation for a facility of the facilities and a specified route of the plurality of routes; and enabling, by the processor, operational functionality of an apparatus with respect to the facility and the specified route in accordance with the recommendations.

The present invention advantageously provides a simple method and associated system capable of automating operation optimization and control of facility and route selection.

### BRIEF DESCRIPTION OF THE DRAWINGS

FIG. 1 illustrates a system for improving autonomous software technology associated with defining and assigning delivery nodes, associated clusters, and an associated network; generating associated recommendations; and enabling operational functionality of an apparatus with respect to in accordance with the recommendations, in accordance with embodiments of the present invention.

FIG. 2 illustrates an algorithm detailing a process flow enabled by the system of FIG. 1 for improving autonomous software technology associated with defining and assigning delivery nodes, associated clusters, and an associated network; generating associated recommendations; and enabling operational functionality of an apparatus with respect to in accordance with the recommendations, in accordance with embodiments of the present invention.

FIG. 3 illustrates an internal structural view of the software/hardware of FIG. 1, in accordance with embodiments of the present invention.

FIG. 4 illustrates hardware/software system architecture enabled for automating operation optimization and control of facility and route selection, in accordance with embodiments of the present invention.

FIG. 5 illustrates a mobile and edge device management system, in accordance with embodiments of the present invention.

FIG. 6 illustrates a computer system used by the system of FIG. 1 for improving autonomous software technology associated with defining and assigning delivery nodes, associated clusters, and an associated network; generating associated recommendations; and enabling operational functionality of an apparatus with respect to in accordance with the recommendations, in accordance with embodiments of the present invention.

FIG. 7 illustrates a cloud computing environment, in accordance with embodiments of the present invention.

FIG. 8 illustrates a set of functional abstraction layers provided by cloud computing environment, in accordance with embodiments of the present invention.

### DETAILED DESCRIPTION

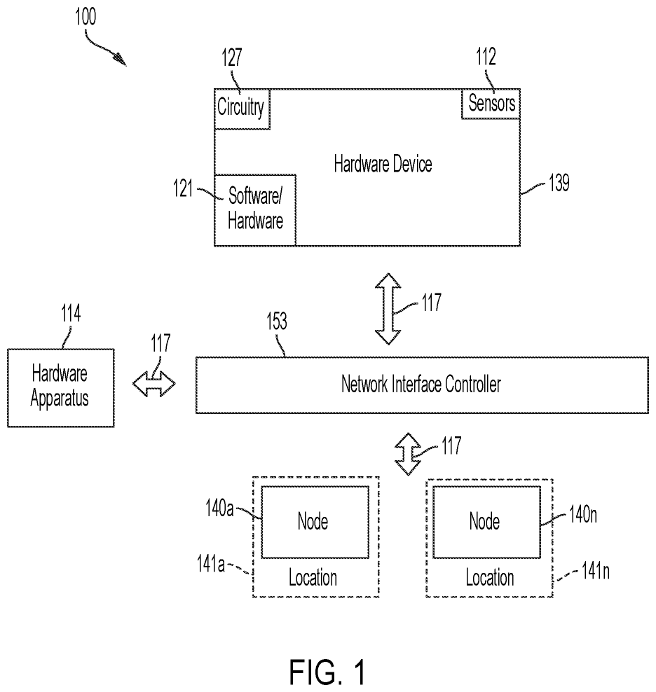

FIG. 1 illustrates a system 100 for improving autonomous software technology associated with defining and assigning delivery nodes, associated clusters, and an associated network; generating associated recommendations; and enabling operational functionality of an apparatus with respect to in accordance with the recommendations, in accordance with embodiments of the present invention. Typical processes associated with a programmability of resources and services comprising key elements of decentralized trust, traceability, transparency, privacy, and security operations may be associated with analysis of a risk of return during a managed field service associated with a recommendation for repair or replacement of a device for and preventing a future return during integration within an omni-channel distribution context. Likewise, typical processes for building an analytical network engine (ANE) and embedding the ANE within an Internet of Things (JOT) edge application to drive closed loop supply chains using multiple logistics services efficiently may be enabled to support continuous operations and increase value to a customer. The aforementioned processes may be associated with a major impact with respect communication service providers moving away from legacy processes thereby providing value added services. The aforementioned solutions may provide limited exposure to an integrated view of applications with respect to system (e.g., server, network, storage, etc.) requirements with respect to utilization of component manufacture processes. Likewise, typical hardware and software suppliers may not be able to comprehend solutions related to mission critical applications being deployed with respect to a client domain controller (DC) environment to determine an impact of failure thereby providing a complex and challenging task with respect to providing an adequate stocks of software/hardware parts and associated arrangement of integrated supply chain management engagement. Therefore, system 100 is configured to reduce an increasing value of returns for a field service repair process while improving an overall customer engagement by developing a series of solutions designed for various phases during process of component replacement. Likewise, system 100 is configured to retrieve and analyzed continuous streams of data at network's edge such that AI computations are performed within an entity location.

System 100 is configured to enable a process for provide cognitive recommendation insights comprising real-time prediction and optimization for hardware and software parts returns to support autonomous operations with respect to managing complex massive Internet of Things (MIoT)/Edge applications via execution of an analytical network engine. The process includes the following features:

1. Execution of natural language processing (NLP) code and natural language generation (NLG) applications within IT Hybrid/Edge/5G services for generating remediation advice based on system and service management (e.g., incident, problem, and change) data to provide a technical understanding of an algorithm's engine and to apply the technical understanding knowledge to entity cases with a deep understanding of IT services and hardware and software operation.
2. Reading of composite data sets and converting the data sets to natural language advice/code to balance technology intervention by automating, trading, or extracting key natural language data elements from service management, health check, vulnerability management, compliance management, and associated reports for feeding associated analysis providing higher satisfaction rates, margins, accuracy, and standardized omnichannel hardware and software operations.
3. Generating profiles associated with product/part returns by directly attributing to a type of entity (e.g., online transactional processing (OLTP), ecommerce, mission-critical, etc.), industry segmentation, and defining an agreed service level (critical vs priority) by IT field service engagement to deliver services for replacing/repairing a device within IT, 5G, Edge, DC, retail, electrical appliance, and home automation systems.
4. Adapting analytical network processes to yield best GSM results during future growth opportunities by considering overall unit attributes for a return based on asset failure predictability and operating environment to stock enough spares based on recommendations. Associated return optimization attributes may comprise, inter alia, item type, item price, unit margin value density, a potential for damage in return transit, relative value for return by courier, a percentage returned to stock for re-allocation, an inspection process, insurance, processing, a product value loss, branding impact, repackaging costs, etc.
5. Subscribing to a remediation advisor to retrieve contextual advice with respect to parts replacement processes. Additionally, subscribing to a logistics service advisor to obtain insight with respect to availability and optimum estimates for replacing parts within an agreed SLA. Likewise, pre-engage and post services of partner logistics are validated for removing bias and allowing fair negotiation for premium contract renewals.
6. Engaging third party logistics (3PL) roles for enhancing a level of sourcing from providing out-tasking in non-strategic transactions to full sourcing in a strategic relationship environment by transforming a 3PL role to become an orchestrator for supporting highest best practices for overall efficiencies while providing closed-loop supply chains services to customers.

System 100 of FIG. 1 includes a hardware device 139, nodes 104 . . . 140n at differing locations 141a . . . 141n, a hardware apparatus 114, and a network interface controller interconnected through a network 7. Hardware device 139 comprises sensors 112, circuitry 127, and software/hardware 121. Nodes 140a . . . 140n comprise various structures or facilities associated with item deliveries or returns. Hardware apparatus 114 may comprise any type of apparatus configured to enable item deliveries and/or returns associated with nodes 104a . . . 104n. For example, hardware apparatus 114 may comprise any type of vehicle and/or robotic device. Hardware apparatus 114 may comprise any vehicle that does not require a human operator to be located within the vehicles 104a . . . 104n such as, inter alia, a remote controlled vehicle (e.g., an aircraft flown by a pilot at a ground control station), an autonomously controlled vehicle (e.g., an aircraft controlled based on pre-programmed flight plans and may include an intelligence algorithm that would enable hardware apparatus 114 to know it's location and self-determine a route to a device requiring a charge), a pre-programmed vehicle, a robotic based structure, etc. Alternatively, hardware apparatus 114 may comprise any type of vehicle that includes a human operator located within the vehicle (e.g., an aircraft, an automobile, a boat or ship, a train, etc.). Hardware apparatus 114 may include, inter alia, an aerial vehicle, a land based vehicle, a marine (water) based vehicle, etc. Hardware device 139 and hardware apparatus 114 each may comprise an embedded device(s). An embedded device is defined herein as a dedicated device or computer comprising a combination of computer hardware and software (fixed in capability or programmable) specifically designed for executing a specialized function. Programmable embedded computers or devices may comprise specialized programming interfaces. In one embodiment, hardware device 139 and hardware apparatus 114 may each comprise a specialized hardware device comprising specialized (non-generic) hardware and circuitry (i.e., specialized discrete non-generic analog, digital, and logic-based circuitry) for (independently or in combination) executing a process described with respect to FIGS. 1-6. The specialized discrete non-generic analog, digital, and logic-based circuitry (e.g., sensors 112, circuitry/logic 127, software/hardware 121, etc.) may include proprietary specially designed components (e.g., a specialized integrated circuit, such as for example an Application Specific Integrated Circuit (ASIC) designed for only implementing an automated process for improving autonomous software technology associated with defining and assigning delivery nodes, associated clusters, and an associated network; generating associated recommendations; and enabling operational functionality of an apparatus with respect to in accordance with the recommendations. Sensors 112 may include any type of internal or external sensors including, inter alia, GPS sensors, Bluetooth beaconing sensors, cellular telephone detection sensors, Wi-Fi positioning detection sensors, triangulation detection sensors, activity tracking sensors, a temperature sensor, an ultrasonic sensor, an optical sensor, a video retrieval device, humidity sensors, voltage sensors, network traffic sensors, etc. Network 7 may include any type of network including, inter alia, a local area network, (LAN), a wide area network (WAN), the Internet, a wireless network, etc.

System 100 is enabled to execute a process for reducing increasing issues associated with an item return to a spare hardware and software parts supplier while improving an overall engagement by developing a solution during various part order and repair phases such as before spare parts are ordered, during an ordering process, and a part procurement and return.

System 100 enables improvement solutions associated with execution of core analytical models such as return risk and cause analyzer, contextual return affinity modeling, customer lifetime value modeling, returns recovery modeling, reverse logistics optimizer, return insight dashboard, etc.

System 100 enables AI powered 3rd party warehouse logistics software for optimizing, integrating, automating, and managing a flow of products within fulfilment or distribution centers, automation, and/or management within supply chains thereby leading to operational efficiency and higher process throughput.

System 100 further enables a reduction in return value thereby improving customer engagement by addressing a return behavior search analysis and optimizing reverse logistics of returns with respect to a nearest geographical location. Likewise, system 100 is configured to provide a scalable option for gathering and generating continuous streams of data at a network's edge and may generate threat aware return pattern search results to prevent future returns,

System 100 may execute software applications with respect to NLP and NLG within IT Hybrid/Edge/5G system to enable an automated process for generating remediation advice based on system and service management (e.g., incident, problem, change, etc.) data. For example, system 100 may be configured to read composite data sets and convert them to natural language advice and associated computer code.

System 100 is configured to retrieve all eligible travel paths associated with return functionality such that all clients and locations are linked to at least one path. Therefore, a global travel path list may comprise a large number of travel paths. Therefore, only a subset of paths is considered for determining a shortest (most efficient) path based on logic as follows:

1. Paths comprising a starting location or ending location within a list of locations are considered for eligible destination computation. The locations may include an original client city and a list of cities within an alternative cluster for an associated client city.
2. From the aforementioned subset of paths, paths based on an open attribute are discarded.

An optimal travel path and an associated relevant entity may be determined as follows:

1. A client location, eligible destinations, and an eligible path list are analyzed to determine a nearest relevant entity and optimal path for a specified day. The determination is used by a user to enable a return or is used by entities for pick-up and return value calculation.
2. A shortest path and cost algorithm is executed for each combination of a source (i.e., a client location) and target pair. Likewise, each distinct destination is retrieved from an eligible destinations list to form a source and destination pair.
3. Computation and time period optimization is enabled with respect to an eligible path subset via execution of the shortest path and cost algorithm.
4. A value is retrieved for each source destination combination.
5. A optimum target and path is recommended based on lowest determined value.

System 100 enables a process for determining an optimal path to enable eco-system entities (e.g., device manufacturers of mobile edge devices) supporting value added services (within applications consisting of massive scale and variability of interconnected MIOT and edge devices) to continuously function by:

1. Providing a field optimized path insight for a given time of day (with respect all possible constraints) to enable a return of defective parts and collect a certified part from a technology partner as suggested by a remediation advisor or by engaging a 3rd party logistics service provider to mitigate a risk and stay within a service level agreement (SLA).
2. Enabling a procurement team to validate a service engagement value before a payment is made to a 3rd party logistics service provider when engaged.
3. Providing a single view graphical user interface to manage mobile and edge devices supporting MIOT applications within a decentralized data environment enabling processing across multiple edge devices and endpoints.
4. Enabling hardware/software features (e.g., bug fixes, upgrades, patches etc.) with respect to partner eco-system devices being used in solution definition and implementation processes.
5. Subscribing to remediation advisor entities for retrieving contextual advice with respect to component replacement.
6. Subscribing to logistics services advisor entities for retrieving an insight with respect to availability and optimum estimates to replace components within an agreed SLA.
7. Validating pre-engage services and post-services associated with partner logistics enabling fair negotiations for premium contract renewals.
8. Enabling centralized management systems to enforce SLA.
9. Assessing risk affinity by proactively managing risk and reputation via implementing audit readiness and compliance postures.

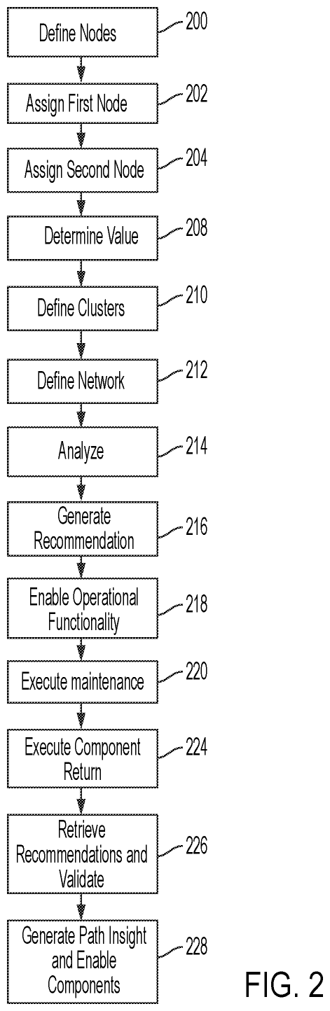

FIG. 2 illustrates an algorithm detailing a process flow enabled by system 100 of FIG. 1 for improving autonomous software technology associated with defining and assigning delivery nodes, associated clusters, and an associated network; generating associated recommendations; and enabling operational functionality of an apparatus with respect to in accordance with the recommendations, in accordance with embodiments of the present invention. Each of the steps in the algorithm of FIG. 2 may be enabled and executed in any order by a computer processor(s) executing computer code. Additionally, each of the steps in the algorithm of FIG. 2 may be enabled and executed in combination by hardware device 139 and hardware apparatus 114. In step 200, a plurality of nodes associated with facilities at differing geographical locations are defined. In step 202, a first node (of the plurality of nodes) is assigned as a location of an entity. In step 204, a second node (of the plurality of nodes) is assigned as a location of a warehouse comprising products for delivery. In step 208, a value for the first node and second node is determined based on a modification of a route extending between the first node and the second node. In step 210, clusters associated with a group of geographical locations of the plurality of nodes are defined. In step 212, a network comprising a plurality of routes extending between the plurality of nodes and the facilities is defined. Each node may be connected to at least one route of the plurality of routes.

In step 214, the plurality of nodes, results of steps 202 and 204, the value, the clusters, and the network are analyzed. In step 216, a recommendation is generated based on results of the analysis of step 214. The recommendation is associated with a facility and a specified route of the plurality of routes. A process for selecting the specified route may include:

1. Determining (based on results of the analysis of step 214) eligible facilities of the facilities.
2. Determining (based on results of the analysis of step 214) eligible routes of the plurality of routes. The aforementioned facility may be selected from the eligible facilities and the specified route may be selected from the eligible routes. The specified route may be a shortest route (of the eligible routes) extending between the plurality of nodes and the eligible facilities. Additionally, the shortest route may be determined via execution of Dijkstra variant algorithm based code. The recommendation may additionally include user and item information associated with travel to the facility via the and specified route.

In step 218, operational functionality of an apparatus is enabled with respect to the facility and the specified route in accordance with the recommendations. A specified time period for enabling operational functionality of the apparatus may be determined. In step 220, maintenance functionality (e.g., with respect to bug fixes, software upgrades, software patches, etc.) is executed with respect to the apparatus. In step 224, a hardware component return management optimization process is executed with respect to a partner eco-system. Additionally or alternatively, a hardware component return cycle associated with a reduced return value may be executed with respect to overall SLAs via optimized route travel during various phases of a reverse logistics lifecycle journey.

In step 226, contextual recommendations are retrieved via a remediation field advisor and/or code. The contextual recommendations are associated with hardware component replacement with respect to associated devices. Likewise, information is retrieved via a logistics services advisor. The information is associated with availability and optimum estimates with respect to the hardware component replacement within an agreed service level agreement (SLA). Additionally, pre-engage services and post-services associated with partner logistics are validated to provide associated negotiations for premium contract renewals.

In step 228, field optimized path insight for a specified time of day is generated with respect to a return of defective hardware components. Likewise, a collection of certified components from a technology partner entity are enabled via a remediation advisor or a 3rd party logistics service provider to mitigate risk with respect to an SLA.

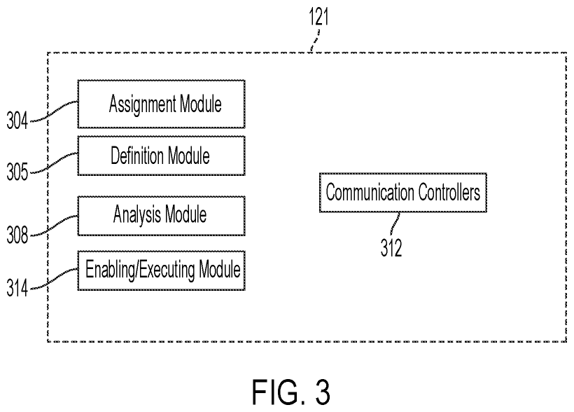

FIG. 3 illustrates an internal structural view of software/hardware (i.e., software/hardware 121) of FIG. 1, in accordance with embodiments of the present invention. Software/hardware 121 includes an assignment module 304, a definition module 305, an analysis module 308, an enabling/executing module 314, and communication controllers 312. Assignment module 304 comprises specialized hardware and software for controlling all functions related to the assigning steps of FIG. 2. Definition module 305 comprises specialized hardware and software for controlling all functionality related to the defining steps described with respect to the algorithm of FIG. 2. Analysis module 308 comprises specialized hardware and software for controlling all functions related to the analyzing steps of FIG. 2. Enabling/executing module 314 comprises specialized hardware and software for controlling all functions related to the enabling and execution steps of the algorithm of FIG. 2. Communication controllers 312 are enabled for controlling all communications between assignment module 304, definition module 305, analysis module 308, and enabling/executing module 314.

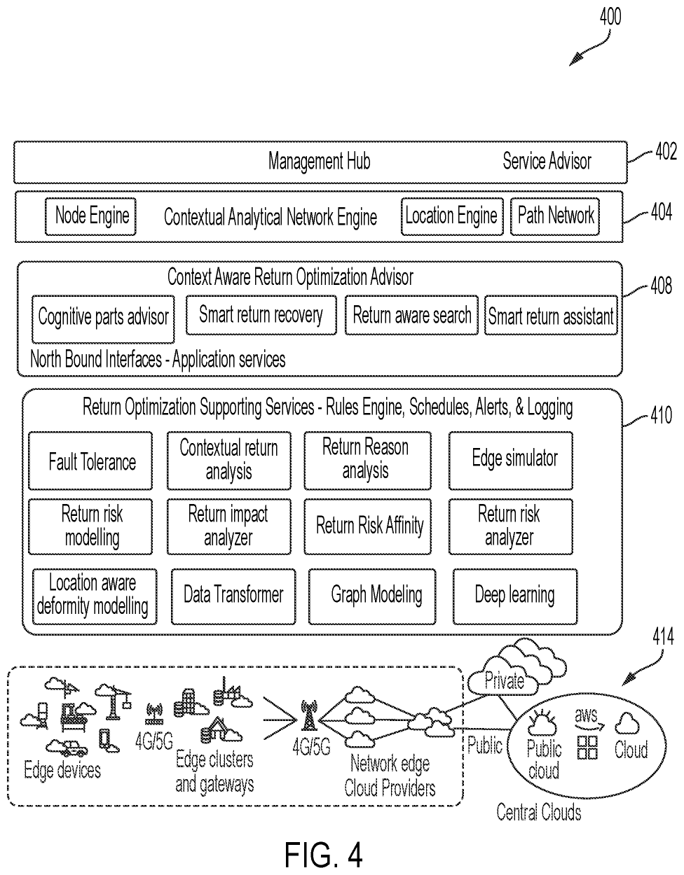

FIG. 4 illustrates hardware/software system architecture 400 enabled for automating operation optimization and control of facility and route selection, in accordance with embodiments of the present invention. Hardware/software system architecture 400 comprises a management hub component 402, a contextual analytical network engine 404, a context aware return optimization advisor component 408, a return optimization component 410, and an edge hardware/software system 414. Management hub component 402a comprises a digital dashboard comprising a management console configured to present data (from multiple sources) within a unified display system. The unified display system is configured to present operational data interpretation. Management hub component 402a is configured to enable a unified digital experience to all process participants associated with differing roles within security management. For example, roles may include, inter alia, a security compliance officer, a service operations manager, etc. Contextual analytical network engine 404 is configured to generate an optimized return logistics network. Context aware return optimization advisor component 408 is configured to provide analysis with respect to previous return patterns and categorize false positives. Return optimization component 410 is configured to:

1. Proactively determine efficiencies with respect to a parts return process.
2. Measure digital supplier attributes associated with a relationship and performance of a system.
3. Assess supplier situational factors (i.e., environment, financial health, operational health, etc.).
4. Assess potential operational disruption events associated with conflict of interest, quality, lockdown, etc.
5. Assess potential impacts associated with rework, a premium with respect to emergency supply, reputation, etc.

Edge hardware/software system 414 comprises an integrated hardware software mechanism configured to assess a risk of alerts service provided by partner/vendor entities via internal subscription processes. Likewise, edge hardware/software system 414 is configured to repair any system component identified as corrupted or defective.

Additionally, edge hardware/software system 414 is configured to enable a daily operational readiness test to manage security and compliance by:
1. Providing security insights.
2. Automating security and compliance by monitoring and assessing risk continuously across an edge environment and enforcing governance monitoring and assessment of risk and compliance objective.

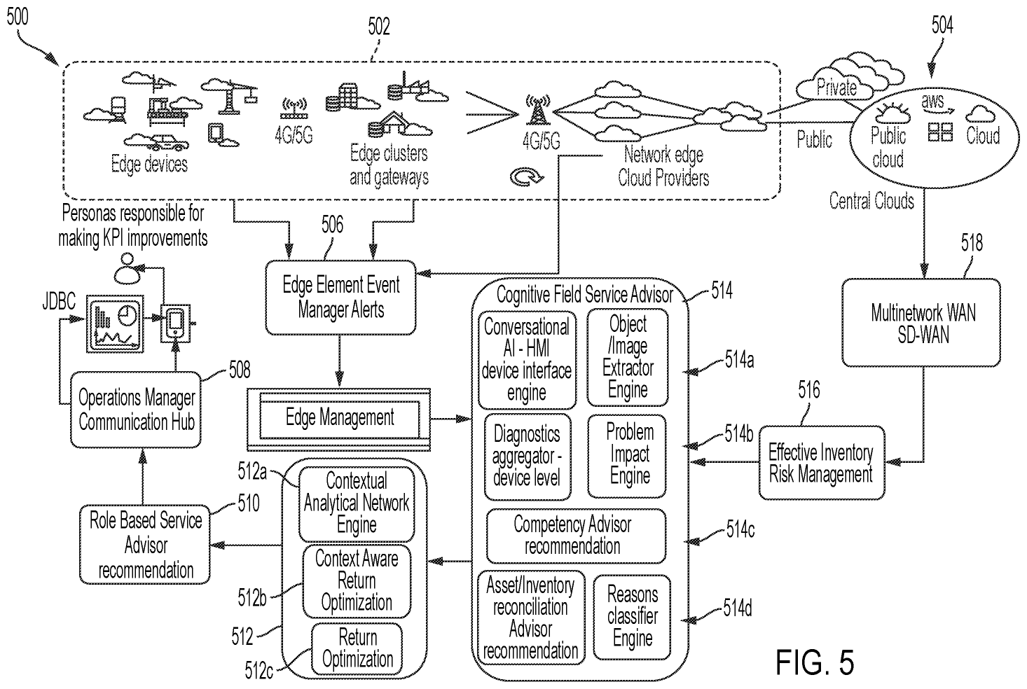

FIG. 5 illustrates a mobile and edge device management system 500, in accordance with embodiments of the present invention. Mobile and edge device management system 500 comprises an edge gateway communication (hardware/software) system 502 communicating with a cloud system 504 for enabling the following components: an edge event component 506, a communication hub 508, a service advisor component 510, a context component 512 (including components 512a, 512b, and 512c), a field service advisor component 514 (including components 514a . . . 514d), an inventory risk management component 516, and a multinetwork component 518. Edge gateway communication (hardware/software) system 502 comprises edge devices edge clusters and gateways, and network systems for enabling mobile and edge device management system 500 functionality. Cloud system 504 comprises a multi-cloud management environment comprising a distribution of cloud assets, software, and applications enabled across several cloud hosting environments (from different cloud service providers) within a single heterogenous architecture. Multinetwork component 518 comprises a multi-cloud network-SD-WAN (software defined wide area network) configured to:

1. Retrieve a redundancy software implemented model that relies on multiple cloud service providers to host an application with in the single heterogenous architecture.
2. Assign a resilient, regional availability, performance, and data sovereignty.
3. Enable integrated manageability, security, and visibility across multi-cloud deployments.
4. Retrieve contextualized experiences across applications and workloads.

Inventory risk management component 516 is configured to address excess consumption (demand), supplier delay (supply), stock divergence (parts handling), etc. with respect to a supplier. Inventory risk management component 516 is further configured to provide contextual inventory risk insight by proactively identifying risk (situational and supplier attributes) and mitigation steps thereby reducing potential impacts (e.g., loss of revenue, recovery expenses, brand, etc.) and optimize value. Edge event component 506 is configured to assess a risk of alert services provided by a partner or vendor via an internal subscription. Likewise, edge event component 506 is configured to repair any system component identified as corrupted or defective and may be enabled to monitor and assess risk and compliance objectives. Communication hub 508 comprises a digital dashboard comprising a management console configured to present data (from multiple sources) within a unified display system as described with respect to management hub component 402a of FIG. 4, supra. Service advisor component 510 is configured to support:

1. A security compliance officer for defining an enterprise policy framework based on Risk, security and compliance.
2. A security compliance engineer (system, network, data, audit readiness, etc.) for performing security controls and compliance management such as implementing policy based control and operations visibility, collecting evidences and acting on alert and notifications.
3. Role based Service owners and operations teams for acting with respect to informed alerts/notifications via recommended remediation where user approval is required.

Component 512a is configured to provide optimized return logistics network design. Component 512b is configured to provide insights on previous return patterns and categorize as false positives to avoid bias. Component 512c is configured to proactively:

1. Realize efficiencies with respect a parts return process.
2. Measure a supplier attribute (e.g., relationship and performance).
3. Assess supplier situational factors (e.g., environment, health, etc.)
4. Assess potential disruption events.
5. Assess potential impacts.

Component 514a is configured to provide prescriptive service instructions and potential parts replacement (if required) to field engineers and optimize the overall service value. Component 514b is configured to interpret risk exposure and provide insights with respect to a potential impact for expected behavior of applications/infrastructure deviating from actual design. Component 514c is configured to study all field issues and qualify hardware software actions enabled to restore critical services. Component 514c is further configured to build incremental improvised knowledge set code to derive an augmented service insight compared with service benchmark. Component 514d is configured to:

1. Classify a reason to derive authentic information.
2. Derive a pattern from service tickets.
3. Sort out clear reasons and map to standard error codes as designed.
4. Control vague and unknown values and categorize as false attributes/positives that may be used to manipulate data classification with utility functions and avoid bias.

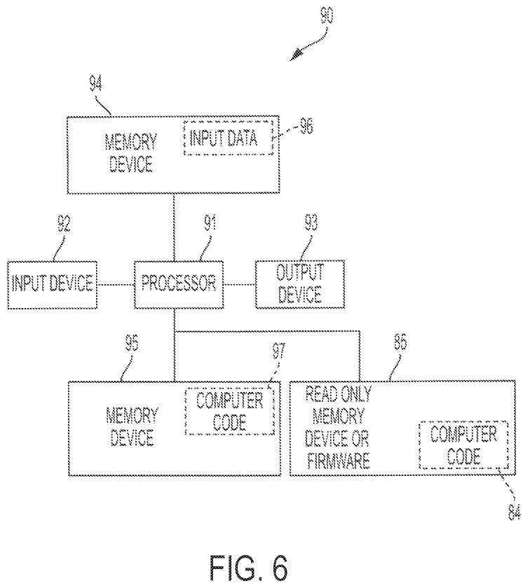

FIG. 6 illustrates a computer system 90 (e.g., hardware device 139 and hardware apparatus 114 of FIG. 1) used by or comprised by the system 100 of FIG. 1 for improving autonomous software technology associated with defining and assigning delivery nodes, associated clusters, and an associated network; generating associated recommendations; and enabling operational functionality of an apparatus with respect to in accordance with the recommendations, in accordance with embodiments of the present invention.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, spark, R language, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, device (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing device to produce a machine, such that the instructions, which execute via the processor of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing device, or other device to cause a series of operational steps to be performed on the computer, other programmable device or other device to produce a computer implemented process, such that the instructions which execute on the computer, other programmable device, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer system 90 illustrated in FIG. 6 includes a processor 91, an input device 92 coupled to the processor 91, an output device 93 coupled to the processor 91, and memory devices 94 and 95 each coupled to the processor 91. The input device 92 may be, inter alia, a keyboard, a mouse, a camera, a touchscreen, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithm of FIG. 2 for improving autonomous software technology associated with defining and assigning delivery nodes, associated clusters, and an associated network; generating associated recommendations; and enabling operational functionality of an apparatus with respect to in accordance with the recommendations. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices Such as read only memory device 85) may include algorithms (e.g., the algorithm of FIG. 2) and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 84 (e.g., including algorithms) may be stored on a static, nonremovable, read-only storage medium such as a Read-Only Memory (ROM) device 85, or may be accessed by processor 91 directly from such a static, nonremovable, read-only medium. Similarly, in some embodiments, stored computer program code 97 may be stored as computer-readable firmware 85, or may be accessed by processor 91 directly from such firmware 85, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve autonomous software technology associated with defining and assigning delivery nodes, associated clusters, and an associated network; generating associated recommendations; and enabling operational functionality of an apparatus with respect to in accordance with the recommendations. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving autonomous software technology associated with defining and assigning delivery nodes, associated clusters, and an associated network; generating associated recommendations; and enabling operational functionality of an apparatus with respect to in accordance with the recommendations. In another embodiment, the invention provides a business method that performs the process steps of the invention on a subscription, advertising, and/or fee basis. That is, a service supplier, such as a Solution Integrator, could offer to enable a process for improving autonomous software technology associated with defining and assigning delivery nodes, associated clusters, and an associated network; generating associated recommendations; and enabling operational functionality of an apparatus with respect to in accordance with the recommendations. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 6 shows the computer system 90 as a particular configuration of hardware and software, any configuration of hardware and software, as would be known to a person of ordinary skill in the art, may be utilized for the purposes stated supra in conjunction with the particular computer system 90 of FIG. 6. For example, the memory devices 94 and 95 may be portions of a single memory device rather than separate memory devices.

### Cloud Computing Environment

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

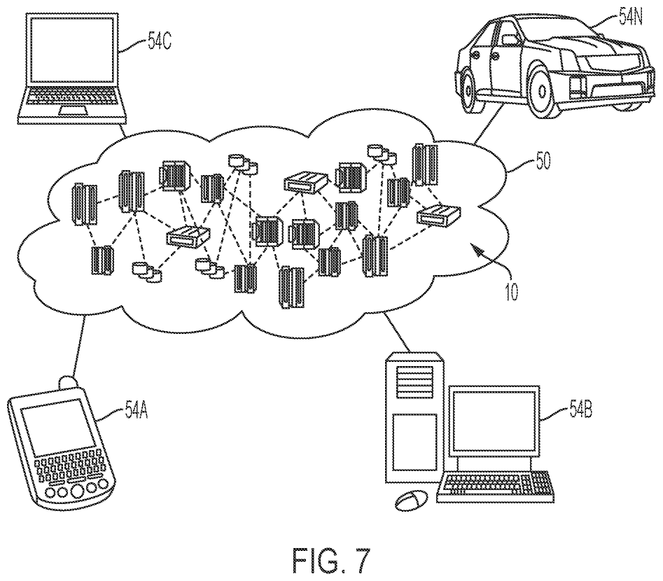

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 12 are intended to be illustrative only and that computing nodes 10 and cloud computing environment 50 can communicate with any type of computerized device over any type of network and/or network addressable connection (e.g., using a web browser).

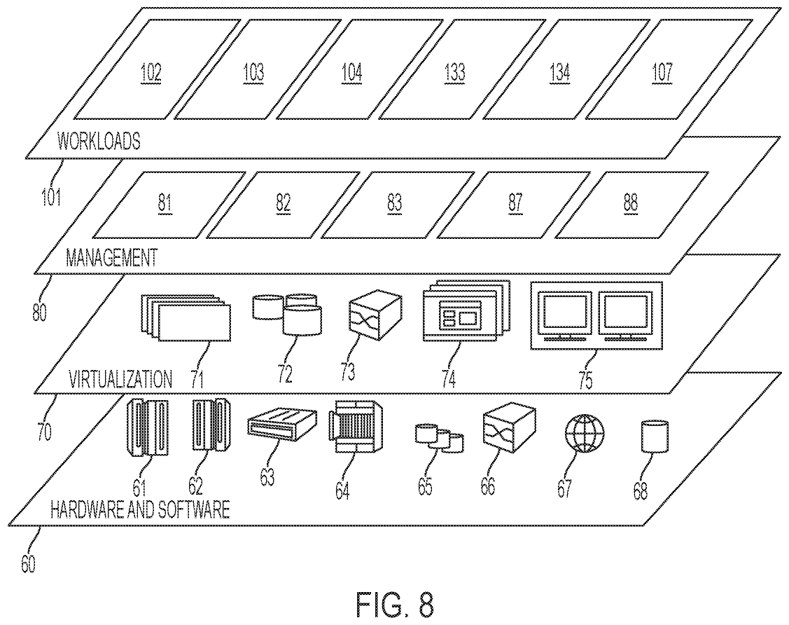

Referring now to FIG. 8, a set of functional abstraction layers provided by cloud computing environment 50 (see FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 87 provides cloud computing resource allocation and management such that required service levels are met. Service Level Agreement (SLA) planning and fulfillment 88 provide pre-arrangement for, and procurement of, cloud computing resources for which a future requirement is anticipated in accordance with an SLA.

Workloads layer 101 provides examples of functionality for which the cloud computing environment may be utilized. Examples of workloads and functions which may be provided from this layer include: mapping and navigation 102; software development and lifecycle management 103; virtual classroom education delivery 133; data analytics processing 134; transaction processing 106; and for improving autonomous software technology associated with defining and assigning delivery nodes, associated clusters, and an associated network; generating associated recommendations; and enabling operational functionality of an apparatus with respect to in accordance with the recommendations 107.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A hardware device comprising a processor coupled to a computer-readable memory unit, the memory unit comprising instructions that when executed by the processor implements an autonomous operation optimization and control method comprising:
defining, by a processor of a hardware device, a plurality of nodes associated with facilities at differing geographical locations;
first assigning, by said processor, a first node, of said plurality of nodes, as a location of an entity;
second assigning, by said processor, a second node, of said plurality of nodes, as a location of a warehouse comprising products for delivery;
determining, by said processor, a value for said first node and said second node based on a modification of a route extending between said first node and said second node;
defining, by said processor, clusters associated with a group of geographical locations of said plurality of nodes;
defining, by said processor, a network comprising a plurality of routes extending between said plurality of nodes and said facilities;
analyzing, by said processor, said plurality of nodes, results of said first assigning and said second assigning, said value, said clusters, and said network;
generating, by said processor based on results of said analyzing, a recommendation for a facility of said facilities and a specified route of said plurality of routes; and
enabling, by said processor, operational functionality of an apparatus with respect to said facility and said specified route in accordance with said recommendations.

2. The hardware device of claim 1, wherein said method further comprises:
determining, by said processor based on said results of said analyzing, eligible facilities of said facilities; and
determining, by said processor based on said results of said analyzing, eligible routes of said plurality of routes wherein said facility is selected from said eligible facilities, and wherein said specified route is selected from said eligible routes.

3. The hardware device of claim 2, wherein specified route comprises a shortest route of said eligible routes extending between said plurality of nodes and said eligible facilities.

4. The hardware device of claim 3, wherein said shortest route is determined via execution of Dijkstra variant algorithm based code.

5. The hardware device of claim 1, wherein each node of said plurality of nodes is connected to at least one route of said plurality of routes.

6. The hardware device of claim 1, wherein said method further comprises:
determining, by said processor based on results of said analyzing, a specified time period for performing said enabling.

7. The hardware device of claim 1, wherein said method further comprises:
executing, by said processor, bug fixes, software upgrades, and software patches with respect to said apparatus.

8. The hardware device of claim 1, wherein said recommendation comprises user and item information associated with travel to said facility via said and specified route.

9. The hardware device of claim 1, wherein said method further comprises:
executing, by said processor, a hardware component return management optimization process with respect to a partner eco-system.

10. The hardware device of claim 1, wherein said method further comprises:
retrieving, by said processor via a remediation field advisor, contextual recommendations associated with hardware component replacement with respect to associated devices;
retrieving, by said processor via a logistics services advisor, information associated with availability and optimum estimates with respect to said hardware component replacement within an agreed SLA; and
validating, by said processor, pre-engage services and post-services associated with partner logistics to provide associated negotiations for premium contract renewals.

11. The hardware device of claim 1, wherein said method further comprises:
executing, by said processor, a hardware component return cycle associated with a reduced return value with respect to overall SLAs via optimized route travel during various phases of a reverse logistics lifecycle journey.

12. The hardware device of claim 1, wherein said method further comprises:
generating, by said processor, field optimized path insight for a specified time of day with respect to a return of defective hardware components; and
enabling, by said processor, a collection of certified hardware components from a technology partner entity via a remediation advisor or a 3^{rd} party logistics service provider to mitigate risk with respect to an SLA.

13. An autonomous operation optimization and control method comprising:
defining, by a processor of a hardware device, a plurality of nodes associated with facilities at differing geographical locations;
first assigning, by said processor, a first node, of said plurality of nodes, as a location of an entity;
second assigning, by said processor, a second node, of said plurality of nodes, as a location of a warehouse comprising products for delivery;
determining, by said processor, a value for said first node and said second node based on a modification of a route extending between said first node and said second node;
defining, by said processor, clusters associated with a group of geographical locations of said plurality of nodes;
defining, by said processor, a network comprising a plurality of routes extending between said plurality of nodes and said facilities;
analyzing, by said processor, said plurality of nodes, results of said first assigning and said second assigning, said value, said clusters, and said network;
generating, by said processor based on results of said analyzing, a recommendation for a facility of said facilities and a specified route of said plurality of routes; and
enabling, by said processor, operational functionality of an apparatus with respect to said facility and said specified route in accordance with said recommendations.

14. The method of claim 13, further comprising:
determining, by said processor based on said results of said analyzing, eligible facilities of said facilities; and
determining, by said processor based on said results of said analyzing, eligible routes of said plurality of routes wherein said facility is selected from said eligible facilities, and wherein said specified route is selected from said eligible routes.

15. The method of claim 14, wherein specified route comprises a shortest route of said eligible routes extending between said plurality of nodes and said eligible facilities.

16. The method of claim 15, wherein said shortest route is determined via execution of Dijkstra variant algorithm based code.

17. The method of claim 13, wherein each node of said plurality of nodes is connected to at least one route of said plurality of routes.

18. The method of claim 13, further comprising:
determining, by said processor based on results of said analyzing, a specified time period for performing said enabling.

19. The method of claim 13, further comprising:
providing at least one support service for at least one of creating, integrating, hosting, maintaining, and deploying computer-readable code in the hardware device, said code being executed by the processor to implement: said defining said plurality of nodes, said first assigning, said second assigning, said determining, said defining said clusters, said defining said network, said analyzing, said generating, and said enabling.

20. A computer program product, comprising a computer readable hardware storage device storing a computer readable program code, said computer readable program code comprising an algorithm that when executed by a processor of a hardware device implements an autonomous operation optimization and control, said method comprising:
defining, by said processor, a plurality of nodes associated with facilities at differing geographical locations;
first assigning, by said processor, a first node, of said plurality of nodes, as a location of an entity;
second assigning, by said processor, a second node, of said plurality of nodes, as a location of a warehouse comprising products for delivery;
determining, by said processor, a value for said first node and said second node based on a modification of a route extending between said first node and said second node;
defining, by said processor, clusters associated with a group of geographical locations of said plurality of nodes;
defining, by said processor, a network comprising a plurality of routes extending between said plurality of nodes and said facilities;
analyzing, by said processor, said plurality of nodes, results of said first assigning and said second assigning, said value, said clusters, and said network;
generating, by said processor based on results of said analyzing, a recommendation for a facility of said facilities and a specified route of said plurality of routes; and
enabling, by said processor, operational functionality of an apparatus with respect to said facility and said specified route in accordance with said recommendations.
